(19) United States
(12) Patent Application Publication
(10) Pub. No.: US 2025/0042811 A1
(43) Pub. Date: Feb. 6, 2025

(54) CEMENTITIOUS MATERIALS AND METHODS OF MAKING AND USING SAME

(71) Applicant: Wisconsin Alumni Research Foundation, Madison, WI (US)

(72) Inventors: Bu Wang, Madison, WI (US); Robert Anex, Madison, WI (US)

(73) Assignee: Wisconsin Alumni Research Foundation, Madison, WI (US)

(21) Appl. No.: 18/792,831

(22) Filed: Aug. 2, 2024

Related U.S. Application Data
(60) Provisional application No. 63/530,647, filed on Aug. 3, 2023.

(51) Int. Cl. C04B 7/12; C04B 22/06; C04B 22/10

(52) U.S. Cl. CPC C04B 7/12; C04B 22/062; C04B 22/10

(57) ABSTRACT

A method for producing carbon negative cementitious materials utilizing a carbon mineralization-based direct-air capture process. The method comprises a mineralization step wherein a mineral feedstock is contacted with an aqueous carbonate solution at a high initial pH to form a carbonated feedstock containing reactive silica, along with an alkaline solution containing dissolved aluminum. The resulting alkaline solution is then contacted with gaseous carbon dioxide to form a carbonate solution that can be recycled for use in the mineralization step. The dissolved aluminum in the alkaline solution precipitates during carbon dioxide capture and is subsequently redissolved in a hydroxide solution to form alumina. The alumina can be combined with the carbonated feedstock to create geopolymer concrete.

### CROSS-REFERENCE TO RELATED APPLICATIONS

Priority is hereby claimed to U.S. provisional application Ser. No. 63/530,647, filed Aug. 3, 2023, which is incorporated herein by reference.

### FEDERAL FUNDING STATEMENT

This invention was made with government support under DE-FE0031705 awarded by the US Department of Energy and under 2132022 awarded by the National Science Foundation. The government has certain rights in the invention.

### BACKGROUND

Globally, cement production is responsible for the release of about 3 billion tons of carbon dioxide (CO₂) per year, about 8% of total CO₂ emissions (P. J. M. Monteiro et al., Towards Sustainable Concrete. Nat. Mater. 2017, 16 (7), 698-699; B. J. van Ruijven et al., Long-Term Model-Based Projections of Energy Use and CO₂ Emissions from the Global Steel and Cement Industries. Resour. Conserv. Recycl. 2016, 112, 15-36). If produced with current methods, the emissions associated with cement production alone would account for as much as 40% of the world's carbon budget in 2050. About 10-30% of traditional Portland cement is currently replaced by coal fly ash as a supplementary cementitious material. This reduces the carbon footprint while generally improving the product and is mandated in many areas. However, the supply of coal fly ash is dwindling due to the decline of coal power plants and other supplementary cementitious material options suffer from high cost, low reactivity and/or high material variability.

A cement product called geopolymer concrete has a lower carbon footprint than Portland cement, but it also requires large amounts of supplementary cementitious material.

New sources of supplementary cementitious materials that can be used to generate concrete with a lower carbon footprint are needed.

### SUMMARY

The present disclosure addresses the aforementioned needs by providing methods to produce carbon negative cementitious materials utilizing a carbon mineralization-based direct-air capture process. In preferred versions, the methods use an aqueous carbonation cycle to capture CO₂ from the air while simultaneously processing mineral feedstocks such as industrial mineral wastes to enhance their pozzolanic (cementitious) reactivity. The processed mineral feedstocks, storing the captured atmospheric CO₂ as solid carbonate (e.g., CaCO₃), can be used as cementitious material in conventional concrete to reduce Portland cement usage and enhance its durability. The processed mineral feedstocks can also fully replace Portland cement via an alkali activation cementation method. This concrete can be cast-in-place (on-site curing inside forms) or be precast for use in later construction. The concrete offers enhanced durability at equivalent strength, similar cost, and can be formed into reusable building components or recycled as carbon-negative aggregates at the end of life.

One aspect of the disclosure is directed to a method for producing one or more cementitious materials. The method comprises contacting a mineral feedstock with a first solution for a time and under conditions to convert the mineral feedstock into a modified feedstock having enhanced pozzolanic activity with respect to the mineral feedstock. The first solution preferably comprises dissolved carbonate exogenous to the feedstock and dissolved hydroxide exogenous to the feedstock. The modified feedstock generated constitutes a first of the one or more cementitious materials.

In some versions, the first solution has a pH greater than 9.5, greater than 10, greater than 10.5, greater than 11, greater than 11.5, greater than 12, greater than 12.5, or greater than 13, when initially contacted with the feedstock.

In some versions, the dissolved hydroxide comprises an alkali hydroxide.

In some versions, the dissolved carbonate comprises one or more of sodium carbonate, potassium carbonate, sodium bicarbonate, and potassium bicarbonate.

In some versions, the contacting is conducted for a time and under conditions to form a carbonate precipitate. In some versions, the modified feedstock comprises a higher carbonation level than the feedstock.

In some versions, the mineral feedstock comprises silicon and the contacting is conducted for a time and under conditions to form precipitated reactive silica. In some versions, the modified feedstock comprises a higher level of reactive silica than the feedstock.

In some versions, the mineral feedstock is contacted with the first solution for a time and under conditions to generate a second solution having a composition different with respect to a composition of the first solution. Some versions further comprise separating the modified feedstock from the second solution.

In some versions, the feedstock comprises aluminum and the mineral feedstock is contacted with the first solution for a time and under conditions to dissolve in the first solution at least a portion of the aluminum to thereby generate the second solution comprising the dissolved aluminum.

Some versions further comprise contacting the second solution with gaseous carbon dioxide for a time and under conditions to generate a third solution having a composition different with respect to the composition of the second solution.

In some versions, the second solution comprises dissolved hydroxide, and the contacting the second solution with the gaseous carbon dioxide comprises converting at least a portion of the dissolved hydroxide in the second solution to carbonate in the third solution.

Some versions further comprise using at least a portion of the third solution as at least a portion of the first solution in the contacting.

In some versions, the second solution comprises dissolved aluminum, and the contacting the second solution with the gaseous carbon dioxide comprises precipitating at least a portion of the dissolved aluminum from the second solution to generate precipitated aluminum.

Some versions further comprise separating the third solution from the precipitated aluminum.

Some versions further comprise contacting the precipitated aluminum with a fourth solution comprising hydroxide to dissolve at least a portion of the precipitated aluminum and thereby generate a fifth solution comprising the dissolved aluminum. In some versions, the precipitated aluminum is contacted with the fourth solution in the absence of gaseous carbon dioxide. The dissolved aluminum in some versions is in the form of alumina. The alumina can constitute a second of the one or more cementitious materials.

In some versions, the feedstock comprises aluminum and the first solution further comprises Al(OH)₄⁻ exogenous to the feedstock when initially contacted with the feedstock.

In some versions, the feedstock further comprises aluminum and the first solution is pre-saturated with Al(OH)₄⁻ exogenous to the feedstock when initially contacted with the feedstock.

In some versions, the feedstock comprises industrial mineral waste. In some versions, the feedstock comprises an industrial mineral waste selected from the group consisting of coal ash, slag, cement kiln dust, ground glass, and recycled concrete.

Another aspect of the disclosure is directed to cementitious materials formed from the method described herein.

Another aspect of the disclosure is directed to a method of generating concrete with the one or more cementitious materials disclosed herein. The method comprises mixing the one or more cementitious materials with an activator in amounts and for a time effective to form the concrete. In some versions, the mixing comprises combining each of the first of the one or more cementitious materials and the second of the one or more cementitious materials with the activator.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1. A schema of an exemplary workflow of the present disclosure.

FIG. 2. Illustration of an exemplary aspect of the present disclosure for carbon negative concrete production using the method disclosed herein.

FIGS. 3A-3D. Results on sorbent generation using the method disclosed herein on coal fly ash. FIGS. 3A and 3B show the evolution of ash carbonation level (measured by thermogravimetry) (FIG. 3A) and the solution pH (FIG. 3B) over time, with different solutions and alkali-to-solid ratios (Na₂CO₃/S or NaHCO₃/S) at a liquid-to-solid ratio (L/S) of 25 ml/g. FIGS. 3C and 3D show Si (FIG. 3C) and Al (FIG. 3D) concentrations vs. time in the supernatant with varying initial pH. High pH suppresses Si concentration but enhances Al concentration.

FIG. 4. Accumulative heat release in pH=14 NaOH environment at room temperature from isothermal calorimetry showing enhanced early age reactivity of the carbonated fly ash over Class F with similar Si/Al contents.

### DETAILED DESCRIPTION

One aspect of the disclosure is directed to a method for producing one or more cementitious materials. The method comprises contacting a mineral feedstock with a first solution for a time and under conditions to convert the mineral feedstock into a modified feedstock. The modified feedstock preferably exhibits enhanced pozzolanic reactivity with respect to the mineral feedstock. The modified feedstock with enhanced pozzolanic activity thereby constitutes at least a first of the one or more cementitious materials generated with the method disclosed herein.

The mineral feedstock can comprise any composition comprising at least some mineral component. The mineral component can comprise silicates, oxides, sulfates, sulfides, carbonates, native elements, and halides, or any combination thereof. Minerals comprising silicon (e.g., silicates, silicate hydrates, silicon oxides, aluminosilicates) are preferred. Minerals comprising aluminum (e.g., aluminum oxides, aluminosilicates, hydroxyaluminates, aluminates, mixed oxides containing aluminum) are preferred. Minerals comprising calcium (e.g., calcium silicate, calcium aluminosilicate, calcium aluminates) are preferred. The mineral feedstock can comprise an industrial mineral waste. “Industrial mineral waste” refers to any waste or byproducts of the processing of mineral-containing materials. Exemplary processes include mining, ore refining, mineral refining, fossil fuel refining, and fossil fuel combustion, among others. Exemplary industrial mineral wastes include waste rock, mill tailings, coal refuse, wash slimes, spent oil shale, coal ash (e.g., fresh coal ash, reclaimed coal ash, off-spec coal ash, fly ash, and bottom ash), slag (e.g., blast furnace slag, iron slag, steel slag, basic oxygen furnace slag, electric arc furnace slag, and boiler slag), cement kiln dust, ground glass, and recycled concrete, among others.

Unless explicitly specified to the contrary, the term “solution” is used herein to refer to an aqueous solution, wherein “aqueous” refers to containing water as a solvent or medium. In any solution herein, the solution preferably comprises water in an amount of at least 50% v/v, such as at least 55% v/v, at least 60% v/v, at least 65% v/v, at least 70% v/v, at least 75% v/v, at least 80% v/v, at least 85% v/v, at least 90% v/v, at least 95% v/v, or at least 99% v/v. For the avoidance of doubt, such volumes of the solutions account for only the volumes of the liquid portions of the solutions (including any molecules dissolved therein) and do not account for the volumes of any solids contacted, suspended, or dispersed therein.

The first solution preferably comprises dissolved carbonate exogenous to the feedstock and dissolved hydroxide exogenous to the feedstock. “Exogenous to the feedstock” is used herein to refer to an element that is included independently of the feedstock such that it is not derived or generated in situ from the feedstock. The terms “exogenous carbonate” and “exogenous hydroxide” are shorthand phrases used herein to refer to carbonate exogenous to the feedstock and hydroxide exogenous to the feedstock, respectively.

Any carbonate that is sparingly soluble to very soluble in water may be used as the exogenous carbonate in the first solution. Exemplary exogenous carbonates for including in the first solution include sodium carbonate, potassium carbonate, sodium bicarbonate, and potassium bicarbonate. It is generally preferred, but not required, that the first solution is saturated with the exogenous carbonate. In some versions, the first solution has an exogenous carbonate concentration from about 0.01 M to about 3.0 M or more.

Any hydroxide that is sparingly soluble to very soluble in water may be used as the exogenous hydroxide in the first solution. Exemplary hydroxides include NaOH (sodium hydroxide), KOH (potassium hydroxide), LiOH (lithium hydroxide), RbOH (rubidium hydroxide), CsOH (cesium hydroxide), Ca(OH)₂ (calcium hydroxide), Sr(OH)₂ (strontium hydroxide), and Ba(OH)₂ (barium hydroxide). Preferred hydroxides include alkali hydroxides, which include NaOH (sodium hydroxide), KOH (potassium hydroxide), LiOH (lithium hydroxide), RbOH (rubidium hydroxide), and CsOH (cesium hydroxide). The exogenous hydroxide is preferably included in the first solution in an amount effective to confer a pH greater than about 9, such as greater than about 9.5, greater than about 10, greater than about 10.5, greater than about 11, greater than about 11.5, greater than about 12, greater than about 12.5, or greater than about 13. The first solution preferably has such a pH when initially contacted with the feedstock or within 10 minutes, 9 minutes, 8 minutes, 7 minutes, 6 minutes, 5 minutes, 4 minutes, 3 minutes, 2 minutes, or 1 minutes after initially contacting the feedstock.

The mineral feedstock is preferably contacted with the first solution for a time from about 1 minute to about 60 minutes or more, such as up to 24 hours or more, a temperature from about 20° C. to about 100° C., and a pressure of about 1 atmosphere. Times, temperatures, and pressures above and below these values are explicitly within the scope of the method.

The mineral feedstock contacted with the first solution is preferably in the form of a bulk particulate matter having a mean particle diameter no larger than about 1 mm, and more preferably no larger than 100 micrometers. “Mean particle diameter” as used herein refers to the volume moment mean. Particle sizes above and below these values are explicitly within the scope of the method. Smaller particle sizes are preferred because it increases the available surface area, which increases the rate and efficiency of the carbonation reaction.

Mean particle size can be determined by any number of conventional methods, such as sieving analysis, laser diffraction, and dynamic light scattering. These are conventional methods and well known to those skilled in the art.

The mineral feedstock is preferably contacted with the first solution at a loading from about 1 mL to about 500 mL of the first solution per gram of the mineral feedstock. Proportions above and below these values are explicitly included in the scope of the method.

The mineral feedstock is preferably contacted with the first solution for a time and under conditions to form a carbonate precipitate. As described in further detail herein, the formation of the carbonate precipitate can occur from divalent ions being extracted from the mineral feedstock and reacting with the dissolved carbonates in the first solution to form the carbonate precipitates. Exemplary carbonate precipitates include CaCO₃ precipitates. The formation of carbonate precipitates can confer the modified feedstock with a higher carbonation level than that of the feedstock. Methods of measuring carbonation levels of substances are well known in the art, and include measurements of thermogravimetry as described elsewhere herein.

In preferred versions, the mineral feedstock comprises silicon and the contacting is conducted for a time and under conditions to form precipitated reactive silica. The silicon can be included in the mineral feedstock in any form, including an elemental form and/or any compound (e.g., mineral) form. It is preferred that the mineral feedstock comprises the silicon in at least some compound (e.g., mineral) form. As described in further detail herein, the formation of the precipitated reactive silica can occur from elemental or compounded silicon being extracted from the mineral feedstock and precipitating in the form of silicates such as reactive silica and, optionally, aluminosilicates and other silicon-containing compounds. The formation of carbonate precipitates can confer the modified feedstock with a higher level of reactive silica than that of the feedstock. Methods of measuring levels of reactive silica are well known in the art.

The mineral feedstock is preferably contacted with the first solution for a time and under conditions to generate a second solution having a composition different with respect to a composition of the first solution. The term “different” used herein with respect to solutions having different compositions refers to a difference in concentration of at least one component between the two compositions.

In preferred versions, the mineral feedstock comprises aluminum and the contacting the mineral feedstock with the first solution is conducted for a time and under conditions to dissolve in the first solution at least a portion of the aluminum to thereby generate the second solution comprising the dissolved aluminum. The aluminum can be included in the mineral feedstock in any form, including an elemental form and/or any compound (e.g., mineral) form. It is preferred that the mineral feedstock comprises the aluminum in at least some compound (e.g., mineral) form. As described in further detail herein, the aluminum can be dissolved in the form of Al(OH)₄⁻.

As shown below, formulating the first solution at higher pHs, such as a pH greater than about 9, greater than about 9.5, greater than about 10, greater than about 10.5, greater than about 11, greater than about 11.5, greater than about 12, greater than about 12.5, or greater than about 13, increases the formation of precipitated reactive silica and the dissolution of aluminum. Accordingly, the first solution is preferably formulated to have such pHs during the contacting with the mineral feedstock.

After the second solution is formed and the modified feedstock is generated, the modified feedstock is preferably separated from the second solution. Any methods suitable for separating solids from liquids may be used in the separation. Examples include filtration, among other methods.

In some versions, the second solution is contacted with gaseous carbon dioxide for a time and under conditions to generate a third solution having a composition different with respect to the composition of the second solution. The gaseous carbon dioxide can be mixed with any other gases in any proportion and be at any pressure. Atmospheric pressure or greater is preferred. In some versions, the gaseous carbon dioxide is provided in the form of air. In some versions, the gaseous carbon dioxide is provided in a more concentrated form. In some versions, the second solution comprises dissolved hydroxide, wherein the contacting the second solution with the gaseous carbon dioxide comprises converting at least a portion of the dissolved hydroxide in the second solution to dissolved carbonate in the third solution. The carbonate can include any carbonate described above for including in the first solution. The third solution with the increased concentration of dissolved carbonate can then be recycled and used as at least a portion of the first solution in the contacting. The third solution, when recycled, may be supplemented with a separate carbonate and/or hydroxide solution to thereby generate the first solution.

In preferred versions, the second solution comprises dissolved aluminum, and contacting the second solution with the gaseous carbon dioxide precipitates at least a portion of the dissolved aluminum from the second solution to generate precipitated aluminum in contact with the third solution. The precipitated aluminum can be in the form of Al(OH)₃. The precipitation can result from a decrease in pH with the conversion of hydroxide to carbonate upon contacting the gaseous carbon dioxide. In some versions, the dissolved aluminum is precipitated on a surface, such as a surface of a liquid-air contactor.

After formation of the precipitated aluminum, the precipitated aluminum is preferably separated from the third solution. For suspended precipitated aluminum, the precipitated aluminum can be filtered or separated by other methods from the third solution. For precipitated aluminum collecting on a surface, such as a surface of a liquid-air contactor, the precipitated aluminum can be separated from the third solution simply by removing the third solution from the surface.

After separation of the third solution from the precipitated aluminum, the precipitated aluminum can be contacted with a fourth solution comprising hydroxide to dissolve at least a portion of the precipitated aluminum therein to thereby generate a fifth solution comprising the dissolved aluminum. The hydroxide in the fourth solution can comprise any hydroxide discussed herein for including in the first solution and is preferably provided in the fourth solution at a high concentration. The precipitated aluminum is preferably contacted with the fourth solution in the absence of gaseous carbon dioxide, such that neither the precipitated aluminum nor the fourth solution is simultaneously contacted with gaseous carbon dioxide. The dissolved aluminum in the fifth solution can be in the form of alumina. For precipitated aluminum collected on a surface, such as a surface of a liquid-air contactor, the surface can be contacted (such as through flushing the liquid-air contactor) with the fourth solution with no air flow to dissolve the precipitated aluminum. The alumina can then optionally be separated from the fifth solution prior to further use. The generated alumina is cementitious and can thereby constitute at least a second of the one or more cementitious materials generated with the method disclosed herein.

Some versions of the disclosure formulate the first solution to minimize or prevent dissolution of aluminum from the mineral feedstock during the contacting with the first solution. In such methods, the first solution comprises Al(OH)₄⁻ exogenous to the feedstock when initially contacted with the feedstock. In some versions, the first solution is pre-saturated with Al(OH)₄⁻ exogenous to the feedstock when initially contacted with the feedstock.

The method of the disclosure as outlined herein can thereby generate one or more cementitious materials that can be used in downstream applications in the formation of concrete. The cementitious materials can be provided in any form, such as a solid form, a gel form, or a liquid form.

Some aspects of the present disclosure pertain to the use of the cementitious materials disclosed herein to make concrete. The concrete can be made by mixing one or more of the cementitious materials disclosed herein with an activator in amounts and for a time effective to form the concrete. Exemplary activators include alkali activators, such as sodium hydroxide, potassium hydroxide, sodium silicate, and/or potassium silicate, among others. The cementitious materials of the disclosure can be used in the absence of Portland cement to generate geopolymer concrete or can be mixed as a supplementary cementitious material with Portland cement. In some versions, the modified feedstock with the reactive silica and the alumina generated from the fifth solution can be mixed with the activator to generate the concrete. The modified feedstock and the alumina can be mixed in various different proportions to confer various characteristics to the generated concrete.

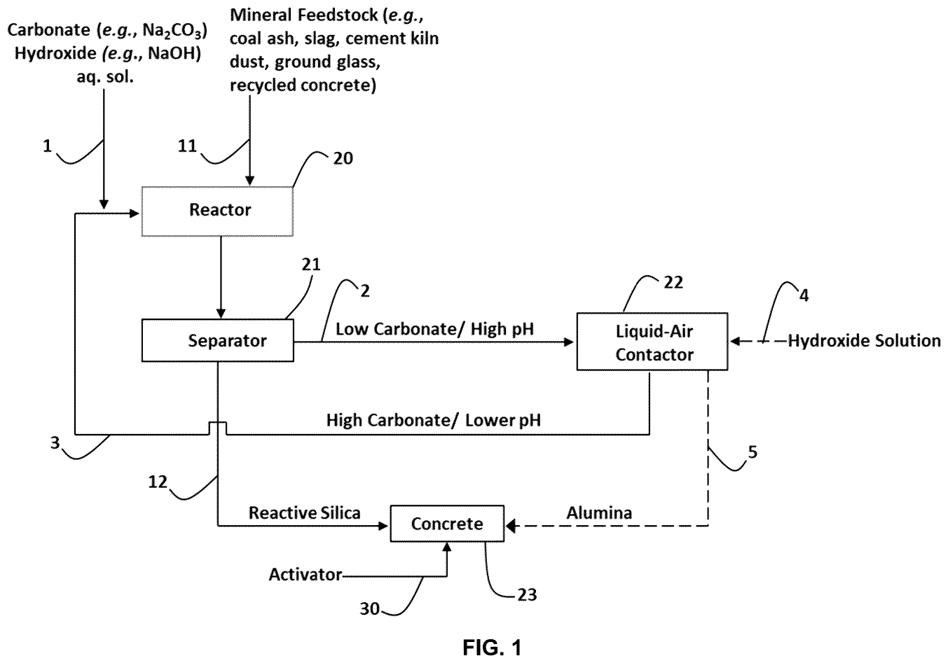

An exemplary workflow of the present disclosure is shown in FIG. 1. A first solution 1 comprising carbonate (such as Na₂CO₃) and a hydroxide (such as NaOH), preferably at a high pH, is fed into a reactor 6 where it contacts a mineral feedstock 11 comprising silicon and aluminum. In the reactor 20, the mineral feedstock 11 is converted to modified feedstock 12 having enhanced pozzolanic activity, due to the precipitation of reactive silica, and enhanced carbonation, due to the formation of carbonate precipitate (such as CaCO₃). Meanwhile, the first solution 1 is converted to a second solution 2 comprising dissolved aluminum (such as in the form of Al(OH)₄⁻). The modified feedstock 12 is then separated from the second solution 2 in a separator 21, such as a filter. The second solution 2 is fed to a liquid-air contactor 22 and exposed to gaseous CO₂. Exposure of the second solution 2 to gaseous CO₂ precipitates the dissolved aluminum to generate precipitated aluminum (such as in the form of Al(OH)₃), and converts hydroxide (such as NaOH) in the second solution 2 to dissolved carbonate (such as Na₂CO₃), thereby generating a third solution 3. The third solution 3 can then be fed back into the reactor 20, optionally mixing with fresh carbonate and hydroxide solution, for further rounds. Periodically, the liquid-air contactor 22 can be drained of the third solution and flushed with a fourth solution 4 comprising hydroxide. The fourth solution dissolves precipitated aluminum in the liquid-air contactor 22 (in the form of alumina) to thereby form a fifth solution 5. The modified feedstock 12 containing the reactive silica and carbonate and alumina from the fifth solution 5 can then be mixed with an activator 30 (such as an alkali activator), in a mold, for example, to thereby form concrete 23.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not.

All combinations of method steps as used herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the disclosure is not confined to the particular construction and arrangement of parts herein illustrated and described, but embraces such modified forms thereof as come within the scope of the claims.

### EXAMPLES

The following examples are included to provide a more complete description of the methods and compositions disclosed herein. They are not intended to limit the scope of the claims in any fashion.

The method described herein can produce carbon-negative concrete building components by utilizing industrial byproducts that can be processed to incorporate sequestered atmospheric CO₂ and be activated to be used as cementitious materials to fully replace Portland cement in the production of precast and cast-in-place concrete. In some versions, the carbon sequestration is performed by a mineralization-based direct air capture process that uses an aqueous carbonation cycle to capture CO₂ from the air at low cost while simultaneously carbonating and upcycling industrial mineral wastes (IMWs) as cementitious materials by enhancing their reactivity. The resulting carbonated IMWs host the sequestered CO₂ in the form of solid carbonate (e.g., CaCO₃). The carbonated IMW is alkali activated and used in producing carbon-negative geopolymer concrete that can be made with zero Portland cement content. The resulting geopolymer concrete of the disclosure offers enhanced durability at equivalent strength and similar cost compared to Portland cement concrete, and can be formed into reusable building components or recycled as carbon-negative aggregates at the end of life.

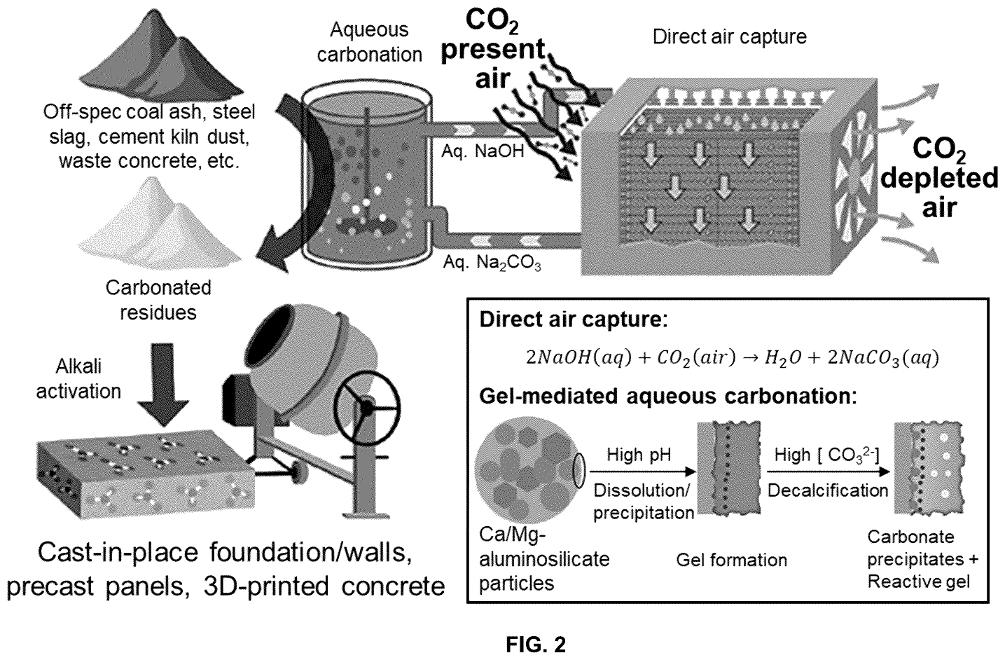

The method of generating the cementitious materials of the present disclosure can employ a two-step cycle using a carbonate/hydroxide solution to rapidly liberate divalent cations and alkalinity from aluminosilicate minerals (FIGS. 1 and 2).

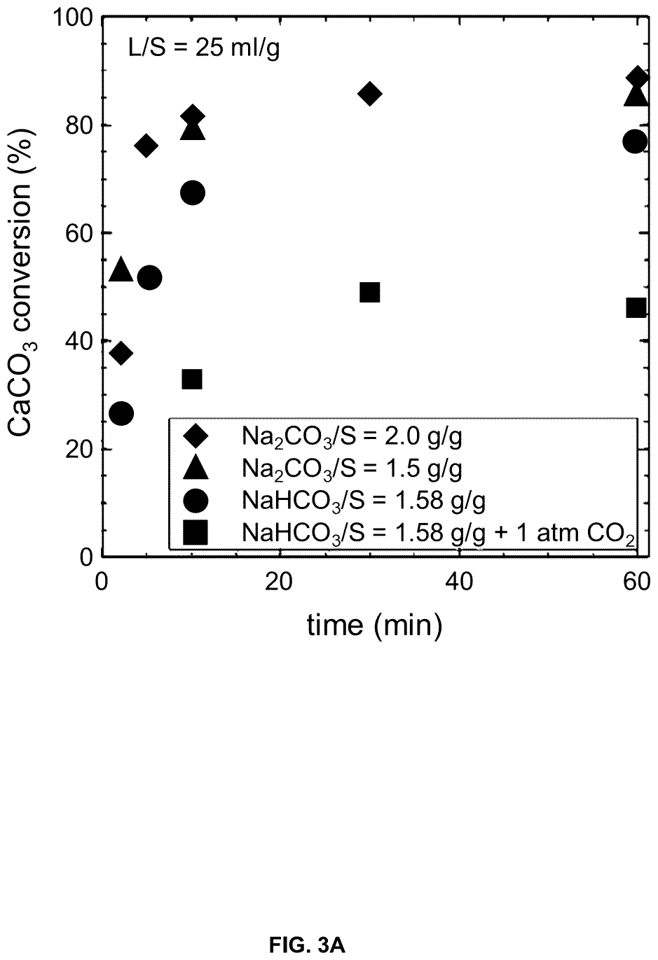

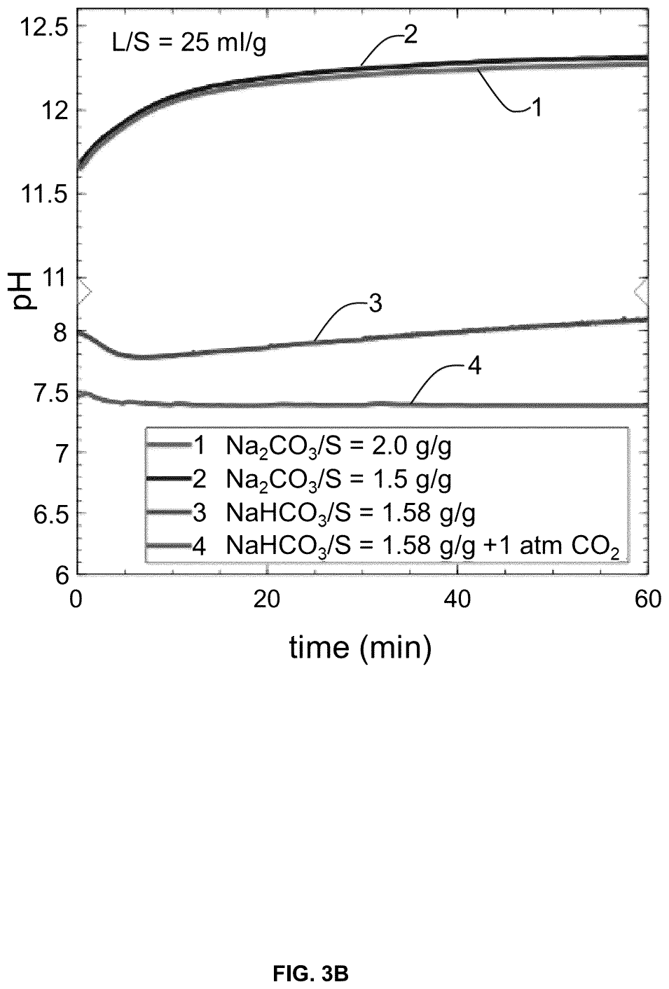

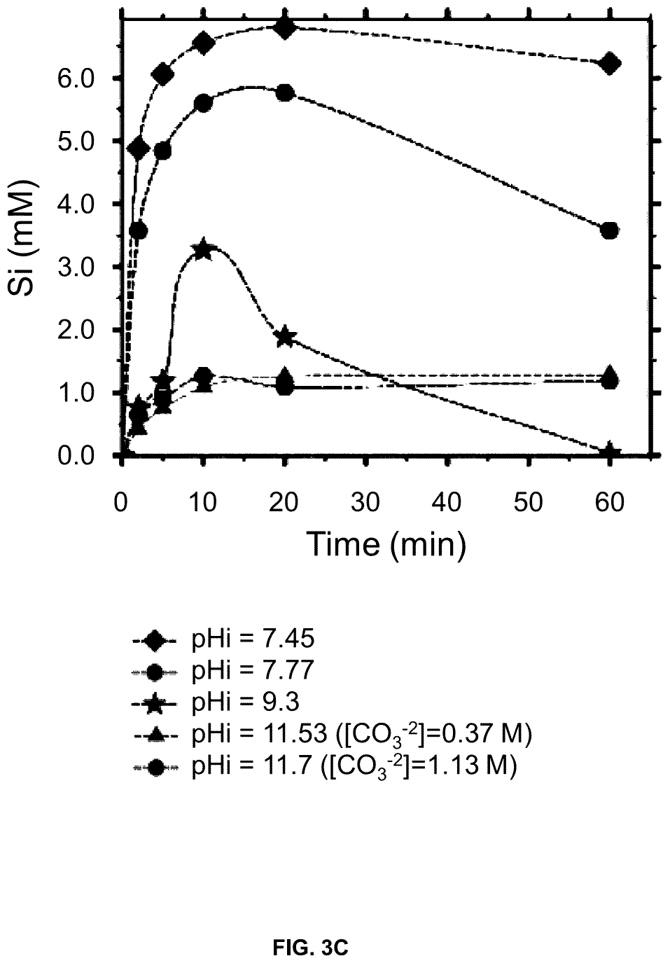

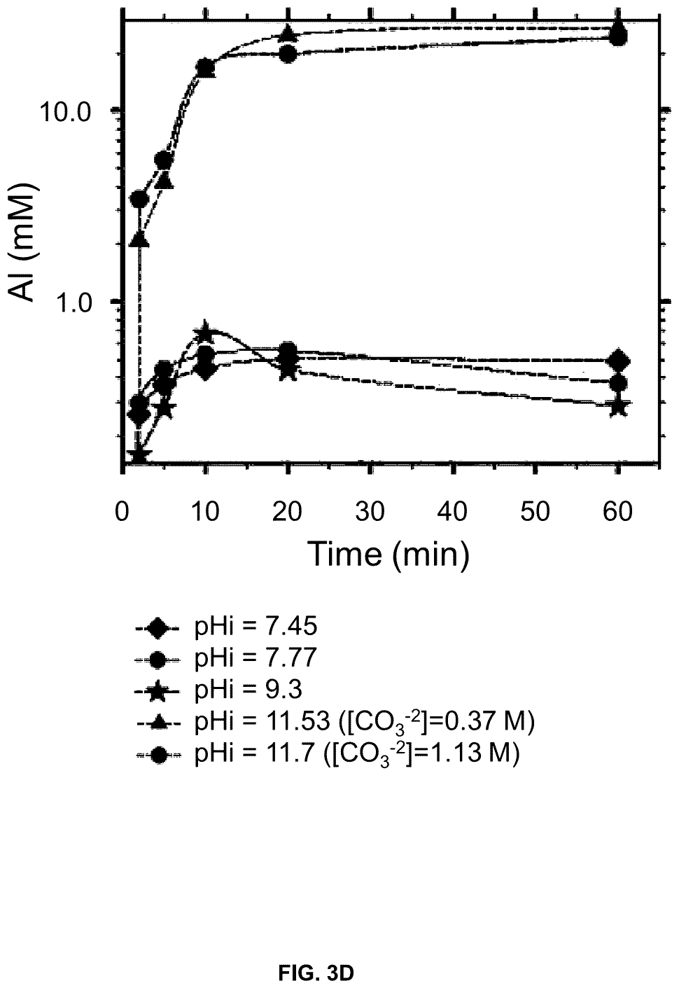

In a first step, an alkaline industrial mineral waste (IMW) is mixed with a carbonate solution (e.g., Na₂CO₃). This extracts divalent ions from the minerals to form carbonate precipitates (e.g., CaCO₃) through a gel-mediated carbonation mechanism. This mechanism offers exceptional carbonation acceleration under ambient conditions. As shown in FIG. 3A, almost 90% of the Ca²⁺ can be extracted from a typical coal ash and converted to CaCO₃ within 30 minutes. By comparison, using traditional approaches based on acidic leaching, only 30% calcium extraction from the same ash is obtained after 24 hours with a liquid-to-solid ratio of 100 ml/g and 5 bar of CO₂ pressure (data not shown). The carbonation reaction also simultaneously generates hydroxide in the solution (e.g., NaOH; FIG. 3B) and precipitates reactive amorphous aluminosilicate gels in the carbonated waste residues.

In a next step, the hydroxide solution is transferred to a liquid-air contactor where it absorbs CO₂ from the atmosphere. This converts the hydroxide back to carbonate (e.g., NaOH to Na₂CO₃), which is circulated back to the first step to repeat the process cycle with fresh mineral wastes.

The mineralization (first) step is preferably performed using high initial pH (>13) with a mixed sodium hydroxide and carbonate solution. The high pH enhances mineral dissolution and dissolves Al in the form of Al(OH)₄⁻. After mineralization, the alkaline solution carrying the dissolved Al can be sent to the air contactor for direct air capture. As the pH of the solution decreases, Al will precipitate as Al(OH)₃ within the air contactor (e.g., on the packing material). Periodically, the air contactor can be flushed with concentrated NaOH solution with no air flow to redissolve the precipitated Al(OH)₃. This solution can then be used as geopolymer concrete mixing solution (can be amended with additional alkali hydroxide) to provide dissolved Al, while the carbonated IMW can serve as the source of reactive silica. The ability to separately control the amounts of reactive silica and alumina is a key advantage of the geopolymer concrete technology described herein compared to traditional alkali activated concrete approaches utilizing raw IMWs.

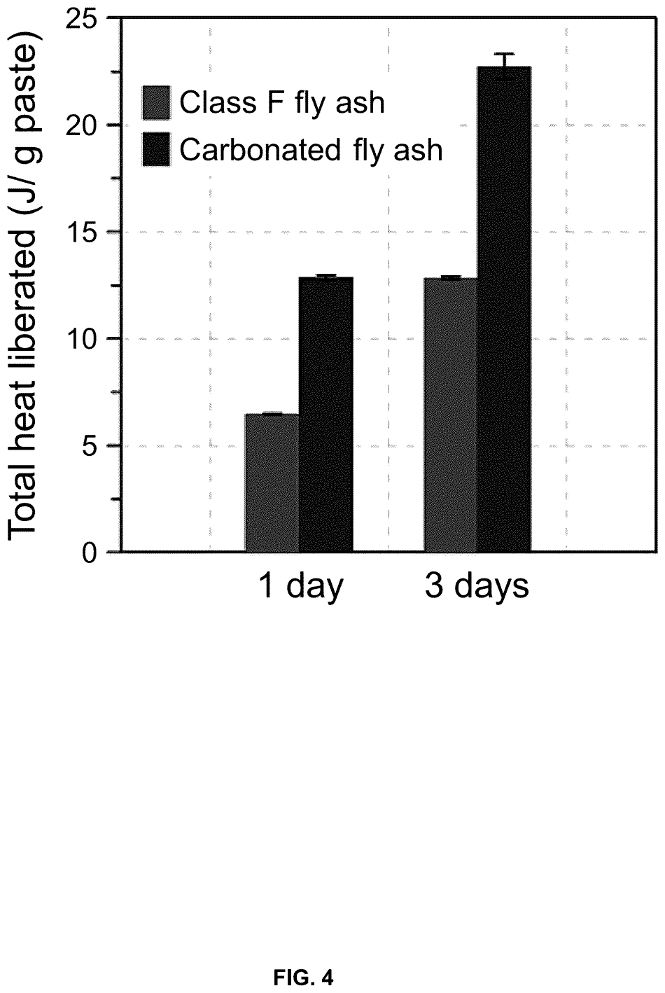

The method disclosed herein can consistently process IMWs, enhancing their reactivity and using them to store atmospheric CO₂. In the aqueous carbonation step, the dissolution of calcium bearing aluminosilicate minerals is encouraged under alkaline conditions in the presence of concentrated carbonate ions. Calcium silicate/aluminosilicate hydrate gel or colloids formed after the initial mineral dissolution are decalcified by carbonate ions to form CaCO₃ (FIG. 2). Simultaneously, Si and Al are also extracted from the IMW (FIGS. 3C and 3D). After gel decalcification, Si is precipitated as hydrated silica while Al either remains in the alkaline solution or precipitates as aluminum hydroxide if pH decreases. This process converts the mineral phases in IMW into reactive silica and alumina, enhancing their pozzolanic reactivity (FIG. 4). This can improve the early age strength gain, which is often lacking when common IMWs are used for alkali activation.

In some versions, the extraction of Al from IMWs can be suppressed by using solutions pre-saturated with Al(OH)₄⁻. Previous studies have demonstrated the role of Al in the mechanical performance of geopolymer concrete as well as its durability, e.g., resistance to sulfate attack and alkali silica reaction (ASR) (Z. Shi et al., Effects of Alkali Dosage and Silicate Modulus on Alkali-Silica Reaction in Alkali-Activated Slag Mortars. Cem. Concr. Res. 2018, 111, 104-115; S. Chen et al., The Influence of Si/Al Ratio on Sulfate Durability of Metakaolin-Based Geopolymer. Constr. Build. Mater. 2020, 265, 120735; D. Vaičiukynienė et al., The Influence of Aluminum Hydroxide (Al(OH)₃) Additive on the Physical and Mechanical Properties of Alkali-Activated Slag. J. Sustain. Archit. Civ. Eng. 2016, 17 (4), 77-83).

To form concrete, the carbonated IMWs can be dewatered and mixed with alkali activator solutions (e.g., sodium hydroxide, potassium hydroxide, sodium silicate, and/or potassium silicate) and aggregates to form a concrete mixture. Here, reactions between the activator and reactive aluminosilicate mineral phases in the residues form sodium aluminosilicate hydrate (NASH) networks that serve as the binder phase of the concrete (J. Davidovits. Geopolymer Chemistry and Applications, 5th Ed; Geopolymer Institute: Saint-Quentin, 2020; A. Kazemian et al., Quantitative Assessment of Parameters That Affect Strength Development in Alkali Activated Fly Ash Binders. Constr. Build. Mater. 2015, 93, 869-876). Concrete formed through this alkali activation process (referred to as geopolymer concrete) can be used in construction like traditional concrete (J. Davidovits. Geopolymer Chemistry and Applications, 5th Ed; Geopolymer Institute: Saint-Quentin, 2020; J. L. Provis. Geopolymers and Other Alkali Activated Materials: Why, How, and What?Mater. Struct. 2014, 47 (1), 11-25). Compared with traditional concrete, geopolymer concrete can offer enhanced durability at equivalent strength and similar cost (e.g., lower alkali silica reaction potential) (I. García-Lodeiro et al., Alkali-Aggregate Reaction in Activated Fly Ash Systems. Cem. Concr. Res. 2007, 37 (2), 175-183; C. You-zhi et al., Aggregate Reaction in Alkali Slag Cement Mortars. J. Wuhan Univ. Technol.-Mater Sci Ed 2002, 17 (3), 60-62; F. Pacheco-Torgal et al., Durability of Alkali-Activated Binders: A Clear Advantage over Portland Cement or an Unproven Issue?Constr. Build. Mater. 2012, 30, 400-405), higher resistance to chloride and sulfate ingression and damages (J. Zhang et al., Durability of Alkali-Activated Materials in Aggressive Environments: A Review on Recent Studies. Constr. Build. Mater. 2017, 152, 598-613; S. A. Bernal and J. L. Provis, Durability of Alkali-Activated Materials: Progress and Perspectives. J. Am. Ceram. Soc. 2014, 97 (4), 997-1008), higher resistance to freeze-thaw cycles (F. Pacheco-Torgal et al., Durability of Alkali-Activated Binders: A Clear Advantage over Portland Cement or an Unproven Issue?Constr. Build. Mater. 2012, 30, 400-405), and higher thermal stability (F. Pacheco-Torgal et al., Durability of Alkali-Activated Binders: A Clear Advantage over Portland Cement or an Unproven Issue?Constr. Build. Mater. 2012, 30, 400-405; T. W. Cheng et al., Fire-Resistant Geopolymer Produced by Granulated Blast Furnace Slag. Miner. Eng. 2003, 16 (3), 205-210; M. B. Mohd Salahuddin et al., A Review on Thermophysical Evaluation of Alkali-Activated Geopolymers. Ceram. Int. 2015, 41 (3, Part B), 4273-4281).

The resulting geopolymer concrete of the disclosure stores atmospheric CO₂ in the form of CaCO₃ that remains stable even against heavy acid rain (D. J. Allen and G. F. Brent, Sequestering CO₂ by Mineral Carbonation: Stability against Acid Rain Exposure. Environ. Sci. Technol. 2010, 44 (7), 2735-2739). Geopolymer concrete precast elements can be designed for 100-year durability and to allow reuse at the end of first service life as elements for new buildings. Like traditional concrete, precast or cast-in-place geopolymer concrete can also be recycled into aggregates at the end of life.

The method disclosed herein can employ a wide range of IMWs, including off-spec and reclaimed coal ash, blast furnace and steel slag, cement kiln dust, ground glass, and recycled concrete. Large amounts of these mineral wastes are stored in waste reservoirs like landfills and ash ponds around the world from decades of industrial operations. For instance, there are 7.6-14.6 Gt of coal ash, 4.2-6.4 Gt of steel slag, and 9-12 Gt of cement kiln dust (P. Renforth et al., Silicate Production and Availability for Mineral Carbonation. Environ. Sci. Technol. 2011, 45 (6), 2035-2041; D. B. Müller et al., Exploring the Engine of Anthropogenic Iron Cycles. Proc. Natl. Acad. Sci. 2006, 103 (44), 16111-16116; E. S. Rubin et al., Integrated Environmental Control Modeling of Coal-Fired Power Systems. J. Air Waste Manag. Assoc. 1997, 47 (11), 1180-1188; G. Kaladharan et al., Review, Sampling, and Evaluation of Landfilled Fly Ash. Mater. J. 2019, 116 (4), 113-122). Substantial (>8.0 Mt per year) quantities of recycled glass containers are also generated and landfilled each year, especially in large metropolitan areas (A. Kaminsky et al., Ground-Glass Pozzolan for Use in Concrete. Concr. Int. 2020, 42 (11), 24-32). Utilizing these materials alone in the geopolymer concrete production of the disclosure has the potential to support global concrete production at the current level for more than a decade while sequestering 2 Gt of CO₂ per year directly from the atmosphere. Additionally, the carbonation process partially leaches Ca and Al out of IMWs, making the carbonated residue a highly reactive amorphous silica with high potential for geopolymerization to serve as concrete's binder phase.

The method disclosed herein provide a unique ability to control the formation of NASH gel in geopolymer concrete by controlling the overall reactive content as well as the ratio between reactive Si and Al in the cementitious mixture.

The cementitious materials produced by the method of the disclosure provide several advantages over traditional SCM: (1) They are carbon negative, storing 10-20 wt. % CO₂ as solid carbonates; (2) They have higher pozzolanic reactivity induced by the gel-mediated carbonation process (1.7-2 times more reactive, based on cumulative reaction heat release over 24 hours in a 30/70 SCM/cement blend). This allows concrete to cure faster or to use higher SCM content to achieve the same strength; (3) They improve cement hydration thanks to the CaCO₃ precipitates serving as nucleation centers for the hydration products.

Most of low-carbon concrete technologies now rely on carbonation curing. They either achieve only very small emission reduction or can only work with small and thin precast elements. Other methods to address the carbon emissions from cement production include point-source carbon capture and storage and alternative chemical processes such as sulfate calcination (e.g., Brimstone's process). These methods still use high-temperature processes and are therefore energy and cost intensive.

In comparison, the geopolymer concrete of the present disclosure sequesters 199 kg of CO₂ per cubic meter of concrete and can replace conventional ready-mix concrete. It is compatible with existing construction technologies (i.e., both cast-in-place and precast), equipment, and workforce. It has mechanical performance similar to conventional concrete and better durability. The cost is also comparable to conventional Portland cement concrete.

What is claimed is:

1. A method for producing one or more cementitious materials, the method comprising contacting a mineral feedstock with a first solution for a time and under conditions to convert the mineral feedstock into a modified feedstock having enhanced pozzolanic activity with respect to the mineral feedstock, wherein the first solution comprises dissolved carbonate exogenous to the feedstock and dissolved hydroxide exogenous to the feedstock, and wherein the modified feedstock is a first of the one or more cementitious materials.

2. The method of claim 1, wherein the first solution has a pH greater than 9.5 when initially contacted with the feedstock.

3. The method of claim 1, wherein the dissolved hydroxide comprises an alkali hydroxide.

4. The method of claim 1, wherein the dissolved carbonate comprises one or more of sodium carbonate, potassium carbonate, sodium bicarbonate, and potassium bicarbonate.

5. The method of claim 1, wherein the contacting is conducted for a time and under conditions to form a carbonate precipitate.

6. The method of claim 1, wherein the modified feedstock comprises a higher carbonation level than the feedstock.

7. The method of claim 1, wherein the mineral feedstock comprises silicon and the contacting is conducted for a time and under conditions to form precipitated reactive silica.

8. The method of claim 7, wherein the modified feedstock comprises a higher level of reactive silica than the feedstock.

9. The method of claim 1, wherein the contacting the mineral feedstock with the first solution is conducted for a time and under conditions to generate a second solution having a composition different with respect to a composition of the first solution.

10. The method of claim 9, further comprising separating the modified feedstock from the second solution.

11. The method of claim 9, wherein the feedstock comprises aluminum and the contacting the mineral feedstock with the first solution is conducted for a time and under conditions to dissolve in the first solution at least a portion of the aluminum to thereby generate the second solution comprising the dissolved aluminum.

12. The method of claim 9, further comprising contacting the second solution with gaseous carbon dioxide for a time and under conditions to generate a third solution having a composition different with respect to the composition of the second solution.

13. The method of claim 12, wherein the second solution comprises dissolved hydroxide and wherein the contacting the second solution with the gaseous carbon dioxide comprises converting at least a portion of the dissolved hydroxide in the second solution to carbonate in the third solution.

14. The method of claim 12, further comprising using at least a portion of the third solution as at least a portion of the first solution in the contacting.

15. The method of claim 12, wherein the second solution comprises dissolved aluminum and wherein the contacting the second solution with the gaseous carbon dioxide comprises precipitating at least a portion of the dissolved aluminum from the second solution to generate precipitated aluminum.

16. The method of claim 15, comprising separating the third solution from the precipitated aluminum.

17. The method of claim 15, comprising contacting the precipitated aluminum with a fourth solution comprising hydroxide to dissolve at least a portion of the precipitated aluminum therein to thereby generate a fifth solution comprising the dissolved aluminum in the form of alumina, wherein the alumina is a second of the one or more cementitious materials.

18. The method of claim 17, wherein the precipitated aluminum is contacted with the fourth solution in the absence of gaseous carbon dioxide.

19. The method of claim 1, wherein the feedstock comprises aluminum and the first solution further comprises Al(OH)₄⁻ exogenous to the feedstock when initially contacted with the feedstock.

20. The method of claim 1, wherein the feedstock comprises aluminum and the first solution is pre-saturated with Al(OH)₄⁻ exogenous to the feedstock when initially contacted with the feedstock.

21. The method of claim 1, wherein the feedstock comprises an industrial mineral waste.

22. The method of claim 1, wherein the feedstock comprises at least one of coal ash, slag, cement kiln dust, ground glass, and recycled concrete.

23. A cementitious material comprising the one or more cementitious materials formed from the method of claim 1.

24. A method of generating concrete with the one or more cementitious materials of claim 1, the method comprising mixing the one or more cementitious materials with an activator in amounts and for a time effective to form the concrete.

25. The method of claim 24, wherein the mixing comprises combining each of the first of the one or more cementitious materials and the second of the one or more cementitious materials with the activator.
